(19) United States
(12) Patent Application Publication
(10) Pub. No.: US 2009/0226581 A1
(43) Pub. Date: Sep. 10, 2009

(54) Combination Food Basting, Flavor Injecting, Temperature Limiting Device

(76) Inventor: Daniel B. Ballenger, Trebur (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/396,526

(22) Filed: Mar. 3, 2009

Related U.S. Application Data
(60) Provisional application No. 61/033,478, filed on Mar. 4, 2008.

(51) Int. Cl. A23L 1/315; A47J 37/00

(52) U.S. Cl. 426/281; 99/347

(57) ABSTRACT

A basting bag automatically injects basting liquid into food being cooked by beans of hallow spikes in communication with a basting liquid reservoir. The spikes are pressed into the food to be cooked. By cooling or freezing the bag, cooking differentials due to the consistency of the food, for example white meat and dark meat of poultry, or due to varying thickness of the food can be compensated for.

### CROSS-REFERENCE TO RELATED APPLICATIONS

This application claims the benefit of U.S. provisional application Ser. No. 61/033,478 filed Mar. 4, 2008.

### BACKGROUND OF THE INVENTION

1. Field of the Invention

The invention is directed to the cooking of food while automatically basting, and a device suitable for use therein.

2. Background Art

Many types of meat products, particularly turkeys or other kinds of poultry, are difficult for novice cooks to prepare due to the varying speeds at which certain flesh types reach an appropriate degree of doneness. White breast meat cooks more quickly than dark meats and hence loses much of its moisture by the time other flesh types reach a temperature sufficient for safe consumption. This deficiency applies to other foods on occasion, as well.

In the past, flavoring packages have been applied to meat during the cooking process, in order to gradually add flavoring to the meat while cooking. An example of the latter is the flavoring dispenser disclosed in U.S. Pat. No. 4,299,851. However, merely adding flavorings to the outside of the meat is not entirely satisfactory, and this is especially true of meat products with low fat content such as pork loin, turkey, chicken, etc. These may become dry inside despite continued basting. Pork products, for example, even when cooked in water, may still have a dry and uninviting texture. Moreover, the pouch and its method of use described in U.S. Pat. No. 4,299,851 does not solve the problem of uneven baking. While this unevenness is most noticeable between the breast portion and dark meat portions of poultry such as chicken, it may also affect other types of meat, for example beef tenderloin, where one end of the tenderloin is noticeably narrower and thus faster cooking then the other end.

### SUMMARY OF THE INVENTION

This invention provides a simple method of providing such a cooling method and with the additional attributes of protecting outer surfaces of the meat from burning and/or drying as well as providing an in place device to introduce basting liquids directly into the meat product.

### BRIEF DESCRIPTION OF THE DRAWINGS

FIG. 1 illustrates one embodiment of a basting bag in accordance with the invention.

FIG. 2 illustrates an embodiment of a basting bag in accordance with the invention showing a spike and a perforation.

### DETAILED DESCRIPTION OF THE PREFERRED EMBODIMENT(S)

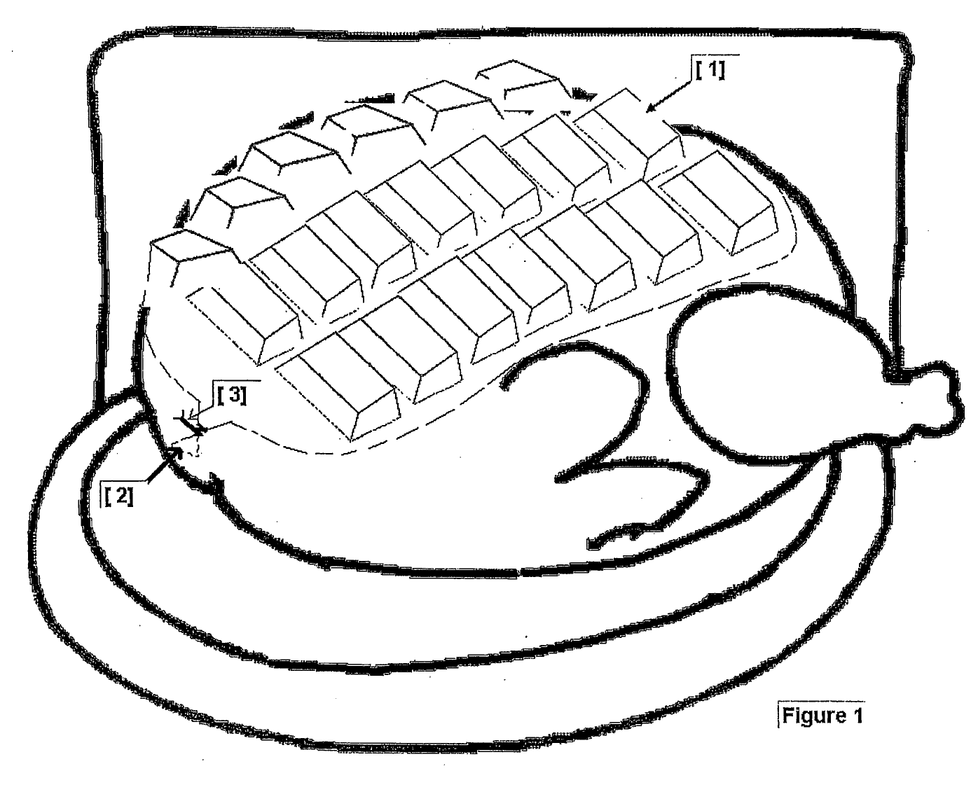

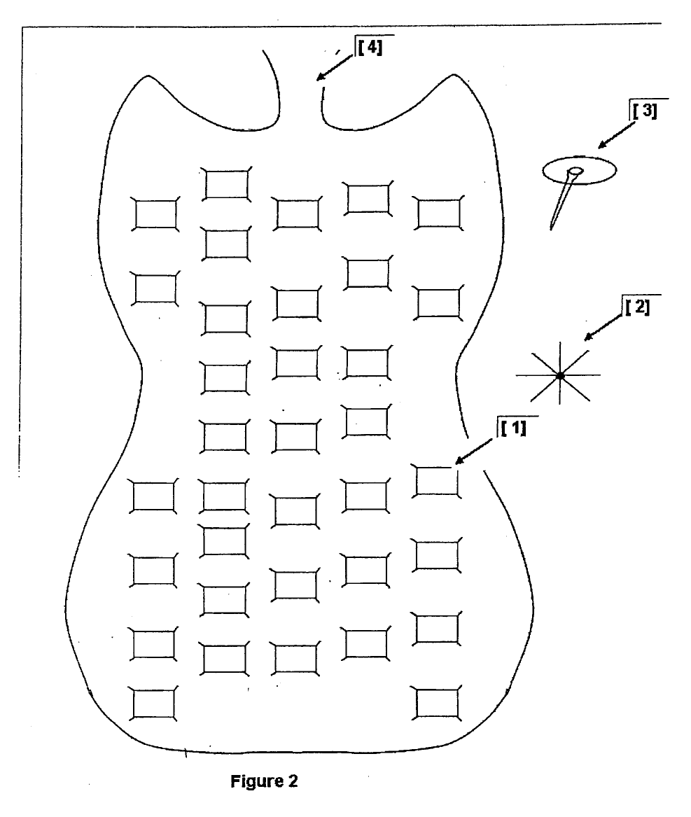

The device may be constructed in the form of a flexible pouch or bag, similar in form to a common ice-cube bag, made of heat and frost-proof materials, the lower layer of which is flat and the upper layer of which contains protuberances, cells, or other compartments which hold basting liquids. The cells may be rectangular in shape (pictured FIG. 1 [1] and FIG. 2 [1]), or of any other shape and may vary in size. They may be aligned in rows, the number of which can be varied to accommodate varying sizes of meat products. They may also be aligned in other patterns to accommodate different shapes of meat products. A number of apertures (pictured FIG. 2 [2]), typically a stampout in the lower layer (or other type apertures) are distributed along the lower layer which convey basting liquids from the cells through hollow needles or spikes (pictured FIG. 2 [3]) (also of frost and heat resistant materials) affixed to the lower layer and anchored by their sharp points into the meat product itself. The apertures are designed to prevent the rapid escape of liquids without the application of pressure.

The pouch is filled by way of an elongated opening (Pictured FIG. 1 [2] and FIG. 2 [4]) at one end which can be sealed with a twist-tie (Pictured FIG. 1 [3]) of frost and heat-proof material. The cook pours basting fluids into the opening which then distributes itself throughout the cells. The pouch is then placed into a freezer with the flat side up to prevent leakage. The spikes can alternatively be equipped with small caps to prevent leakage, or can be pre-cast with twist-off tabs which leave a sharp, pointed end after removal.

Other embodiments are suitable as well. The bag may assume numerous shapes depending upon the type of food being cooked. For example, with turkey or chicken, the bag is preferably configured so as to cover both sides of the breast meat during cooking. To facilitate contact, silicone rubber bands may also be supplied to help the bag in close contact with the skin. For tenderloin or other cuts, a square or rectangular bag may be provided to wrap around the relevant portions of the meat product.

The particular form of the bag may also be altered. For example, a bag with a continuous interior space rather than protuberances, cells, or compartments may be utilized as the storage reservoir for the liquid to be contained therein. Also, the manner of closure may be altered, for example a “zip lock” closure, a screw on cap, etc. In a particularly preferred embodiment, the bag is made of a washable plastics material configured for reuse.

The bottom of the device, i.e. the portion which contacts the food item being cooked, has protuberances which are hollow so as to allow the passage of fluid out of the bag, and are elongate and preferably pointed so that they can be pushed into the food product so that the liquid is dispensed below the surface, i.e. under the skin and preferably into the breast meat itself when used with poultry, for example. The actual size and distribution of the “spikes” is not overly critical, and these may be, by way of example, from 0.5 to 10 mm at their base, and preferably from 0.5 to 5 mm, more preferably 0.5 to 3 mm, and yet more preferably 0.5 to 2 mm at their tips. The length of the spikes is generally less than 25 mm, more preferably less than 20 mm, and most preferably from about 5 mm to about 15 mm. The spacing is also not critical, and may be such, for example, that there are 0.1 to 4 spikes/cm2, more preferably 0.25 to 1/cm2. The spacing need not be regular geometrically, and may be more concentrated in areas most prone to dry out.

In use, the bag is pressed onto the meat product to at least partially cause spikes to penetrate the surface. Not all the spikes must do so. To ensure that contact is maintained during baking, heat resistant bands or ties may be disposed appropriately. During cooking, liquid penetrates into the food product, maintaining the moisture thereof, and optionally adding flavorings. The liquid in the pouch may be predominately water, but may also constitute fats, cooking oils, etc., either alone or in the form of an aqueous emulsion, and optionally with spices, tenderizers, etc.

In a preferred embodiment, the bag containing the liquid is frozen, for example with the spikes in an upward facing position, and placed upon the meat just prior to cooking. When this preferred embodiment is employed, the liquid contents of the bag must at least partially melt before liquid will be injected into the meat. Due to absorbtion of the heat of melting (heat of fusion), this will keep the portion of meat adjacent to the bag at a much lower temperature during the initial phase of cooking, preventing an overcooked scenario for those portions which would ordinarily cook more rapidly.

The bag will ordinarily be removed prior to full cooking so that the meat can be browned or broiled on its surface.

On cooking day the poultry or other meat product is prepared for cooking as normal. Prior to introduction into the oven the pouch is removed from the freezer, the spikes are rendered free from obstruction (caps, spikes and the like when applicable). Lubricating agents (oil, melted butter and the like) may be applied to the surface of the meat product to prevent sticking. The pouch is inverted to fit over the target area and the cook affixes the pouch to the meat product by firmly pressing the spikes into the meat product.

The pouch is left in place affixed to the meat product, either in a refrigerated environment, or at a higher temperature for a period of time sufficient to lower the temperature of the targeted area relative to other parts of the meat product. The meat product, with emplaced pouch, may be introduced into the oven with the basting liquids either in a frozen state, a semi-frozen state, or completely liquified, according to the cook's preference.

During the cooking process the basting material will have reached a state of fluidity sufficient to allow its expulsion through the spikes into the meat product. At various intervals during the cooking process, the cook can apply gentle pressure, using a common oven mitt or other insulated device, to effect an expulsion of the basting liquid out of the pouch and introducing it directly into the meat product. The pouch may be left in place for the duration of the cooking process, or, when the basting liquids are fully depleted, the pouch may be removed to allow for browning of the meat product in the final stages of the cooking process.

The device may be sold empty, allowing the cook to prepare his/her own basting liquids, or may be sold pre-prepared with basting liquids provided by the manufacturer. A cheaper version of the pouch can be sold without spikes, but which releases basting materials onto the meat product as opposed to subcutaneous introduction.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of cooking a food product and simultaneously basting and preventing overcooking of portions of the food product, comprising:
a) supplying a bag adapted in shape to cover at least a portion of the food product, the bag containing at least one fluid reservoir, and hollow spikes protruding from a side of the bag to be placed on the food product, the hollow portions of the spikes being in communication with the fluid reservoir;
b) placing the bag upon a food product to be cooked and causing at least some of the spikes to penetrate the surface of the food product;
c) cooking the bag and food product assembly, whereupon liquid leaves the bag through the spikes and enters the food product.

2. The method of claim 1, further comprising:
d) removing the pouch from an at least partially cooked food product and browning or broiling a surface of the food product.

3. The method of claim 1, wherein the bag is supplied containing liquid, and has no sealable openings for refilling the bag.

4. The method of claim 1, wherein the liquid comprises water, fat, oil, flavorings, or a combination thereof.

5. The method of claim 1, wherein prior to step b), the liquid contents of the bag are cooled.

6. The method of claim 1, wherein prior to step b), the liquid contents of the bag are at least partially frozen.

7. The method of claim 1, wherein the food product is poultry.

8. The method of claim 1, wherein the food product is a turkey.

9. A basting bag, comprising:
a) a liquid reservoir, optionally refillable,
b) a surface containing a plurality of hollow spikes, the hollow spikes in communication with the fluid reservoir so as to allow fluid to exit the bag through the hollow spikes.

10. The basting bag of claim 9, which is a substantially planar bag having a top surface, a bottom, hollow spike-containing surface, and a fluid reservoir between the top and bottom surfaces.

11. The basting bag of claim 9, wherein the top surface comprises a plurality of raised compartments which can be filled with fluid.

12. The basting bag of claim 9, comprising a plastics material which is heat resistant.

13. The basting bag of claim 10, wherein the bottom hollow spike-containing surface comprises a heat resistant plastics material.

14. The basting bag of claim 12, wherein the top surface comprises an aluminum foil surface, optionally with a thermally resistant plastics film adjacent thereto.

15. The basting bag of claim 13, wherein the top surface comprises an aluminum foil surface, optionally with a thermally resistant plastics film adjacent thereto.

16. The basting bag of claim 9, which is heat resistant and freezing resistant.

17. The basting bag of claim 9, wherein the hollow spike-containing surface is constructed of a heat resistant thermoplastic selected from the group consisting of polyamide, polyimide, polyethersulfone, polyetherketone, polyethetherketone, polyetherketoneetherketone, polysufone, polyarylene sulfide, polyarylcarbonate, or silicone.
